(19) United States
(12) Patent Application Publication
(10) Pub. No.: US 2005/0259179 A1
(43) Pub. Date: Nov. 24, 2005

(54) Electro-optical shutter

(76) Inventors: Jerry Lynn Robertson, Newton Centre, MA (US); Charles MacIan Robertson, Seattle, WA (US)

Correspondence Address: HAYES, SOLOWAY P.C., 175 CANAL STREET, MANCHESTER, NH, 03101, US

(21) Appl. No.: 10/852,067

(22) Filed: May 24, 2004

(51) Int. Cl. H04N 5/238

(52) U.S. Cl. 348/367

(57) ABSTRACT

An electro-optical shutter apparatus provides optical deblurring of images captured with a video camera. A liquid crystal element in the optical path of a video camera selectively interrupts the optical path of the video camera. An electronic circuit contains a microprocessor that executes a software algorithm to control the liquid crystal element and synchronize its operation to the video camera. Based on input from the user, the liquid crystal element opens and closes at the appropriate times to reduce the time available for the video camera to sample the desired image. When capturing an action sequence, therefore, the camera captures less motion of the subject during each sampling period, resulting in decreased motion blur.

### FIELD OF TECHNOLOGY

The present invention is generally related to multimedia, and more particularly is related to an apparatus for deblurring action sequence images during acquisition with a digital video camera.

### BACKGROUND

During filming of a movie with a film movie camera, an image is captured on each frame of a film with an ‘open shutter.’ The result of a long ‘open shutter’ film exposure can be blurring of a captured image, known as a blurring effect. When a viewer sees the film, the visual cortex of the brain of the viewer attempts to correct the blurring effect by comparing the image to what the viewer sees in everyday life. The blurring effect is caused by the film movie camera capturing excessive movement of a subject due to the relatively long film exposure time compared to, for example, shorter film exposure time available on a still camera. The relatively long exposure time is the result of a fixed open shutter setting.

In a modern motion picture film movie camera, film may be exposed at different rates, twenty-four (24) frames-per-second being one common frame rate. A shutter of this modern film movie camera is commonly implemented by a disc that rotates between the film and a camera lens. Due to this relationship, the shutter is also known as, and referred to hereinafter as, a disc. One frame of film is exposed during each revolution of the disc. Typically, the disc contains a semi-circle having only about one hundred eighty (180) degrees of the disc available for exposure. Therefore, as the disc rotates, the shutter is opened to expose the film to approximately one-half of the frame time. The shutter is closed for the other half of the frame to prevent exposure of the film while the camera moves the film for the next exposure.

For film movie cameras, mechanical light-sampling systems may be used to reduce the motion blur effect caused by the long exposure time. A mechanical light-sampling system reduces the sampling time of the image during each frame of film. The mechanical light-sampling system on the film movie camera is sometimes a fixed window of less than one hundred eighty (180) degrees on the rotating disc positioned in an optical path of the film movie camera between the film and the camera lens.

The fixed window is sometimes a pie-shaped opening fixed at about forty-five (45) degrees of the rotating disc, but other window openings are possible to vary the sampling time. The fixed window opening is commonly referred to as the ‘shutter angle.’ As the disc rotates, the film is exposed only for the time the fixed window opens the optical path. Reducing the film exposure time results in capturing less movement in an action sequence, thereby dampening the blurring effect.

As noted above, when a viewer sees a blurred image on the film, the brain detects sharper images and smoothes the transitions between the scenes in the action sequence by comparing the images to what the viewer sees in everyday life. Therefore, sampling the images before they are collected on the film reduces the motion blurring effect by capturing sharper images with less motion in each image and allowing the brain to fill in the transitions.

A disadvantage of the mechanical light-sampling system is the fixed sampling window. Various filming conditions may require different sized sampling windows to achieve a desired effect. While other window sizes may be available (e.g., 90 degree windows), they may not be available on the same disc. To obtain an accurate sampling window, a different disc with a different sized sampling window is installed.

Digital video cameras replace film with charge coupled devices (CCD) or similar electro-optical integrated circuit devices that continually collect photons of light and convert them to stored electronic charges. At fixed intervals of time, referred to as sampling periods, these stored charges are delivered, via a complex operation, to an analog-to-digital converter (A/D). The A/D converts the image represented by the stored electronic charges to a completely digital representation.

Because of the fixed sampling period of the digital video camera, often about thirty (30) samples-per-second, the amount of image information captured from an action sequence can result in the appearance of ‘motion blur’ when the action sequence is reproduced for a viewer.

Motion blur captured by a digital video camera may conceivably be reduced using a mechanical light-sampling system as described above. Digital video cameras, however, feature small size and low power consumption. Using a motor-driven disc in the optical path to eliminate motion blur effects would be unwieldy and inconvenient, and would unacceptably increase power consumption.

Thus, a heretofore unaddressed need exists in the industry to address the aforementioned deficiencies and inadequacies.

### SUMMARY OF THE INVENTION

Embodiments of an electro-optical shutter provide a system and method for deblurring video sequences captured by a video camera.

Briefly described, one embodiment of the electro-optical shutter, among others, can be implemented as follows. The system may contain a video camera, a programmable electronic control circuit that may accept a synchronization signal from the video camera, and a liquid crystal display element positioned in an optical path of the video camera. The synchronization signal from the video camera may indicate a start of an image sampling period (i.e., a time period over which the image capture device collects light and processes a resulting signal).

The microprocessor in the electronic control circuit may execute a software algorithm to control the liquid crystal display element. The liquid crystal display element may be located between a lens and an image capture device. A user interface may be provided for selecting a shutter angle setting. The microprocessor may develop an electrical output signal based on the synchronization signal from the video camera and on one of a plurality of pre-programmed shutter angle settings that may be selected by a user. Within the video camera image sampling period, the electrical output signal from the programmable electronic control circuit may control the liquid crystal display element to adjust a time that the optical path is ‘open’, allowing light to reach the image capture device, and a time that the optical path is ‘closed’, blocking light from reaching the image capture device. Selectively reducing the amount of time available to sample the image by interrupting the optical path reduces the range of motion captured from an action scene. This shorter range of motion results in diminishment or elimination of the ‘motion blur’ effect, resulting in a clearer action sequence.

The electro-optical shutter can also be viewed as providing methods for reducing motion blur in action sequences recorded by video cameras. In this regard, one embodiment of such a method, among others, can be broadly summarized by the following steps: equipping a video camera with an electro-optical shutter; providing power to the camera and the electro-optical shutter; selecting one of a plurality of preprogrammed shutter angle settings; and operating the video camera to record the selected action sequence.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating elements of a first exemplary embodiment of an electro-optical shutter system.

FIG. 2 is a schematic diagram of the programmable electronic control circuit of the first exemplary embodiment of the electro-optical shutter system.

FIG. 3 is a tabulation of a possible selection of shutter angle settings available in the first exemplary embodiment of the electro-optical shutter system.

FIG. 4 is an unscaled illustration of theoretical waveforms representing approximate timing relationships in the first exemplary embodiment of the electro-optical shutter in at least one mode of operation.

FIG. 5 is a flow chart illustrating an exemplary algorithm executed by a microprocessor in a programmable electronic control circuit of first exemplary embodiment of the electro-optical shutter.

FIG. 6 is a flow chart illustrating a method of using the first exemplary embodiment of the present invention shown in FIG. 1.

### DETAILED DESCRIPTION

An electro-optical shutter is a small, lightweight, programmable apparatus that uses a liquid crystal element to optically deblur action sequences captured by a video camera. By synchronizing to a signal from a video sampling system of the video camera, the liquid crystal element precisely interrupts the optical path from a lens of the video camera to an image capture device within the video camera. As described here, a video camera may include any motion picture camera capable of capturing and processing images in an electronic format, as an example, but not limited to, a digital video (DV) camera, which uses an electronic image capture device, such as, but not limited to, at least one charge coupled device.

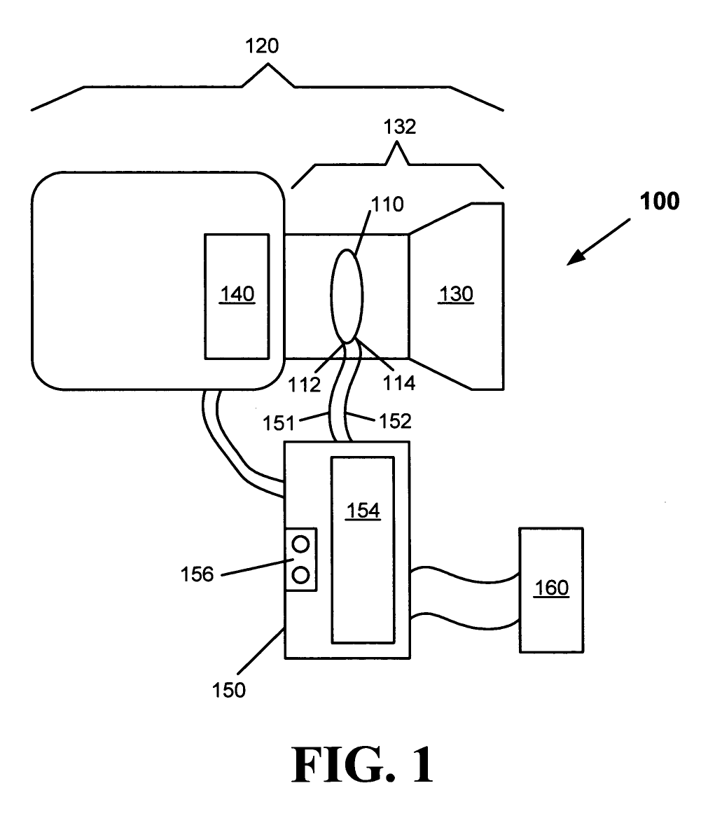

FIG. 1 is a block diagram illustrating the major elements of a first exemplary embodiment of an electro-optical shutter apparatus. The electro-optical shutter apparatus 100 comprises a liquid crystal display (LCD) element 110 disposed in an optical path 132 of a video camera 120. As shown in FIG. 1, the LCD element may be disposed between a lens 130 and at least one image capture device 140. A programmable electronic control circuit 150 configured to control the LCD element 110 may include a microprocessor 154. Power for the electro-optical shutter apparatus 100 may be provided by a battery 160, or may be supplied by another power source. For example, power may be supplied to the electro-optical shutter from a battery of the video camera 120, from an external power source connected to provide power to the video camera 120, or from an external power source connected to provide power to the electro-optical shutter apparatus 100.

The programmable electronic control circuit 150 accepts an electrical synchronization signal from the video camera 120 and an electrical signal from a user interface means 156 corresponding to one of a plurality of preprogrammed ‘shutter angle’ settings that may be selected by a user. The programmable electronic control circuit 150 may output electrical signals to a first terminal 112 of the LCD element 110 and to a second terminal 114 of the LCD element 110.

The output electrical signals from the programmable electronic control circuit 150 may command the LCD element 110 into one of two optical states. The LCD element 110 may be either in a transparent state (hereinafter referred to as the ‘open state’), or in an opaque state (hereinafter referred to the ‘closed state’). In the open state, the LCD element 110 may allow light focused by the camera lens 130 to be transmitted through the optical path 132 and to be collected by the image capture device(s) 140. In the closed state, the LCD element 110 may block light from reaching the image capture device(s) 140.

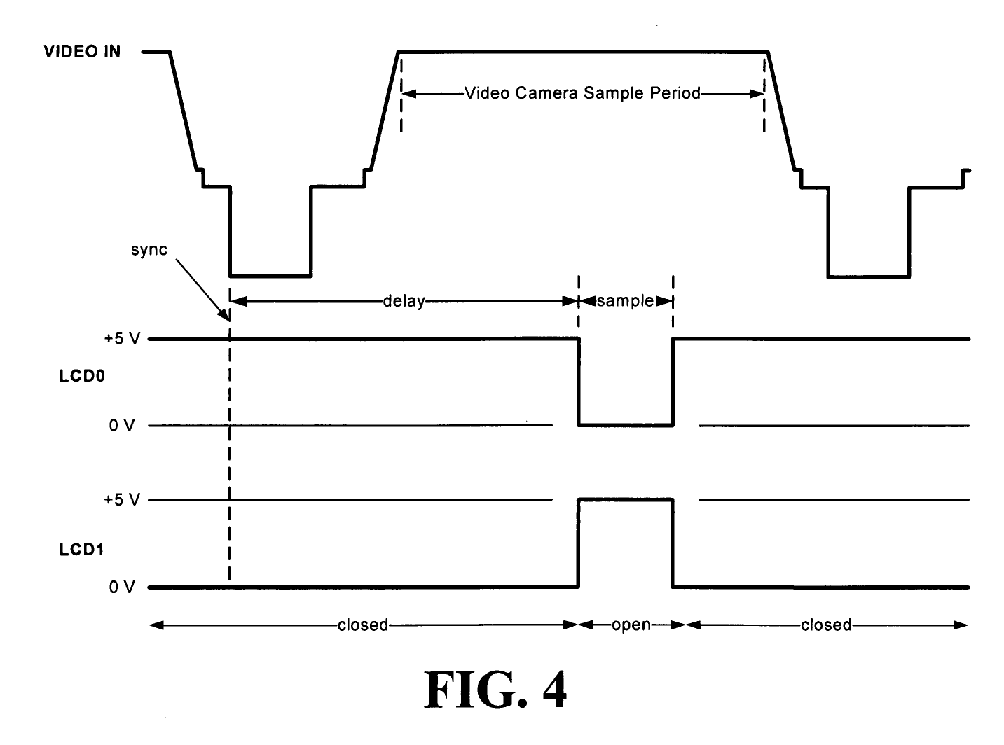

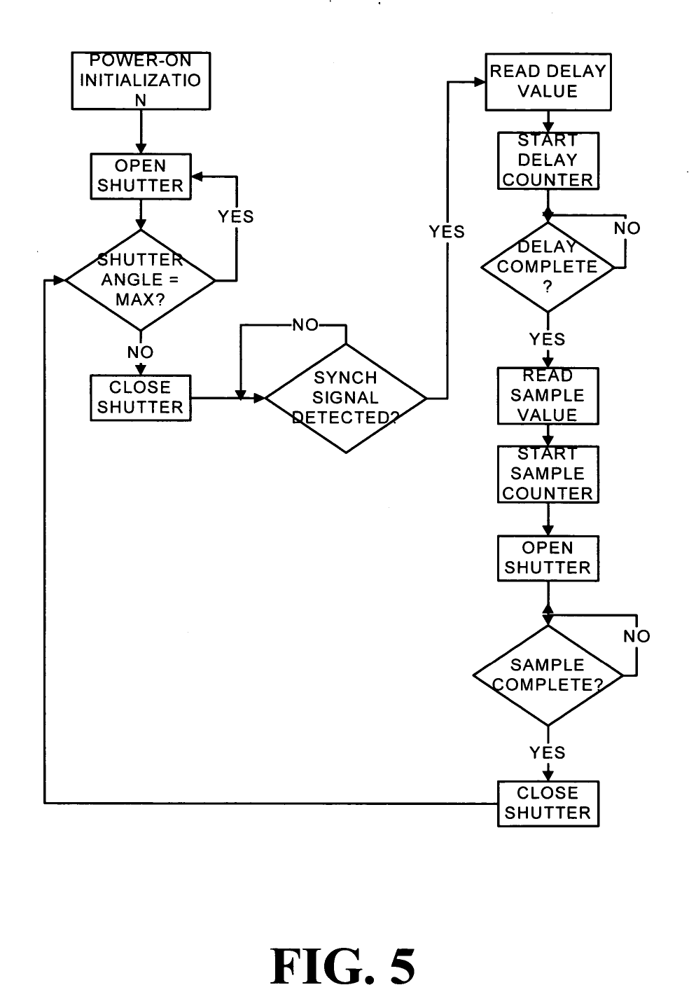

The microprocessor 154 may execute a software algorithm (see FIG. 5) to generate control signals (LCD0, LCD1—see FIG. 4) that are transmitted to the LCD element 110 to provide the required shutter open state time and shutter closed state time in relation to the fixed video sampling time of the video camera 120. The software algorithm may be previously programmed in a memory that may be internal to the microprocessor 154, or may be programmed in a memory device external to the microprocessor 154. The electrical output signals from the programmable electronic control circuit 150 may control the LCD element 110 to adjust the time within the image sampling period that the optical path 132 is in the open state and the time within the image sampling period that the optical path 132 is in the closed state.

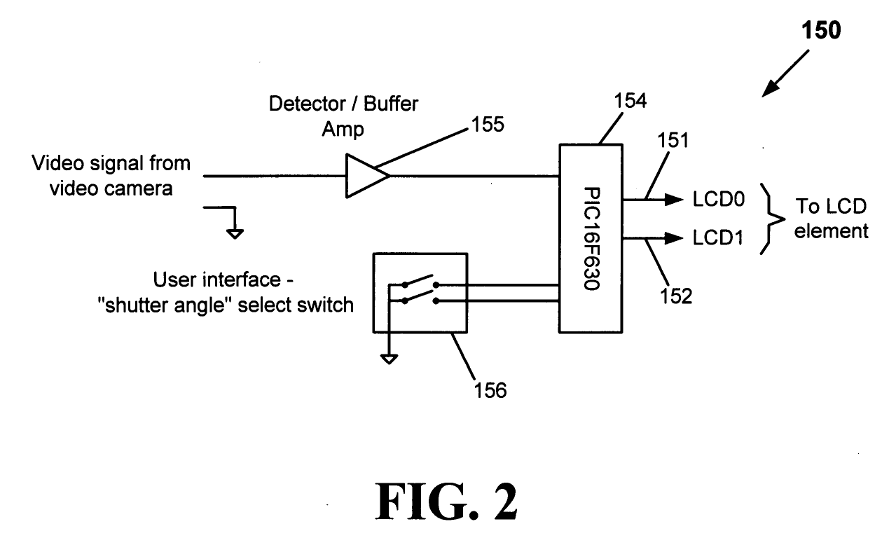

FIG. 2 illustrates the schematic diagram of the programmable electronic control circuit 150 in the first exemplary embodiment of the electro-optical shutter apparatus 100. The programmable electronic control circuit 150 may comprise at least one detector/buffer amplifier stage 155 configured to accept at least one electrical synchronization signal (hereinafter the ‘sync signal’) from the video camera 120. In the first exemplary embodiment of the electro-optical shutter, the sync signal from the video camera 120 is preferably the horizontal sync signal. In alternative embodiments of the electro-optical shutter apparatus 100, other sync signals may be used.

The sync signal may be transmitted from the detector/buffer amplifier stage 155 to the microprocessor 154. In the first exemplary embodiment of the electro-optical shutter apparatus 100 the microprocessor 154 may be, as an example, but not limited to, a PIC16F630 microcontroller manufactured by MICROCHIP having internal program and data memory capability for storing a software program and associated data. Alternative embodiments of the electro-optical shutter apparatus 100 may comprise differing microprocessor/memory configurations including, but not limited to, memory devices external to the microprocessor 154 and microprocessors 154 without internal memory.

The programmable electronic control circuit 150 also accepts input an electrical signal from the user interface means 156 indicating the desired shutter angle (hereinafter the ‘shutter angle signal’). The user interface means 156 may comprise a switch or potentiometer operable by a button or knob. Alternatively, the user interface means 156 may be incorporated into the video camera software menu system. The user interface means 156 may further comprise a display to indicate the selected shutter angle, for example, but not limited to, a digital display or light-emitting diode (LED) display. In the first exemplary embodiment of the electro-optical shutter apparatus 100, the user interface means 156 is a multi-position electromechanical switch. The shutter angle signal from the user interface means 156 may be decoded and stored in a memory location by the microprocessor 154 for later reference to determine the desired shutter angle setting.

The microprocessor 154 uses the sync signal from the video camera 120 and the shutter angle signal from the user interface means 156 to generate control signals to the LCD element 110. The first exemplary embodiment of the electro-optical shutter apparatus 100 comprises a ferroelectric LCD element 110 manufactured by DISPLAYTECH. The ferroelectric LCD element 110 provides fast switching times and operates at low voltages, both desirable characteristics for an optical shutter application. Alternative embodiments of the electro-optical shutter apparatus 100 may comprise different types of LCD elements 110, for example, but not limited to, twisted nematic or active-matrix thin film transistor (TFT) elements, or other electronically controllable shutter means for controllably disrupting the optical path of the video camera 120.

The programmable electronic control circuit 150 may have at least one electrical signal line in communication with the LCD element 110. Referring to FIG. 1 and FIG. 4, the first exemplary embodiment of the electro-optical shutter apparatus 100 comprises at least two (2) electrical signal lines. One electrical signal line 151 (corresponding to signal LCD0) may be in electrical communication with the first terminal 112 of the of the LCD element 110 and the other electrical signal line 152 (corresponding to signal LCD1) may be in electrical communication with the second terminal 114 of the LCD element 110. The programmable electronic control circuit 150 may generate electrical signals to the first terminal 112 and to the second terminal 114 of the LCD element 110 to cause the LCD element 110 to open and to close, thereby permitting or preventing light transmission along the optical path 132, and reducing a period of time that the lens 130 can focus light on the image capture devices 140 during the sampling period of the video camera 120.

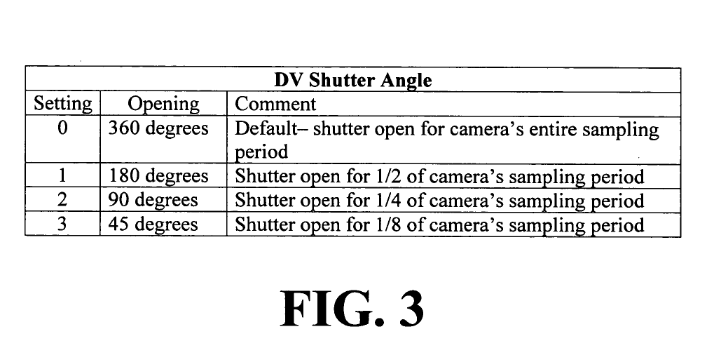

A tabulation of a possible set of selectable shutter angle settings available in the first exemplary embodiment of the electro-optical shutter apparatus 100 is shown in FIG. 3. The electro-optical shutter apparatus 100 may have four (4) selectable shutter angle settings. The shutter angle settings correspond to the LCD element 110 being always open (a default setting), open for one-half (½) of the video camera sampling time, open for one-quarter (¼) of the video camera sampling time, and open for one-eighth (⅛) of the video camera sampling time.

FIG. 4 is an unscaled illustration of theoretical waveforms representing approximate timing relationships used in the first exemplary embodiment of the electro-optical shutter apparatus 100 operating at a shutter angle setting other than the always open, default setting. The LCD element 110 will open when the voltage level on electrical signal line 152 (LCD1) is sufficiently greater than the voltage level on electrical signal line 151 (LCD0). The LCD element 110 will close when the voltage level on electrical signal line 151 (LCD0) is sufficiently greater than the voltage level on electrical signal line 152 (LCD1). In the first exemplary embodiment of the electro-optical shutter apparatus 100, logically opposed five-volt (+5V) signals control operation of the LCD element 110. Alternative embodiments of the electro-optical shutter apparatus 100 may use different control signals, for example, but not limited to, bipolar five-volt signals (+/−5V), or split-supply referenced signals (e.g., 5V+/−5V).

To generate the control signals LCD0 and LCD1 to the LCD element 110, the microprocessor 154 in the programmable electronic control circuit 150 may execute a software algorithm that processes the sync signal from the video camera 120 and the shutter angle signal from the user interface 156 to determine the appropriate operational parameters for the LCD element 110. In the first exemplary embodiment of the electro-optical shutter apparatus 100, the software algorithm is programmed into the microprocessor 154 and resides in the internal memory of the microprocessor 154. In alternative embodiments, the software may reside in a memory device external to the microprocessor 154, for example, but not limited to, a flash memory device. One of ordinary skill in the art will appreciate that a software algorithm may be implemented in many different forms to achieve the same results. Reference to FIG. 4 and FIG. 5 illustrate the description of the software algorithm that follows.

FIG. 5 is a flow chart illustrating an example of an algorithm executed by a microprocessor 154 in a programmable electronic control circuit 150 in the first exemplary embodiment of the electro-optical shutter apparatus 100. After a power-on initialization phase, the microprocessor 154 generates control signals LCD0, LCD1 to open the LCD element 110. In the default state, the LCD element 110 is open allowing normal video camera operation. The microprocessor 154 monitors the shutter angle signal from the user interface means 156. When the user selects a different shutter angle setting (see FIG. 3) through the user interface 156, the microprocessor 154 decodes the shutter angle selection and generates control signals LCD0, LCD1 that are transmitted to the LCD element 110 to close the LCD element 110. The microprocessor 154 then waits for the sync signal from the video camera 120.

After detecting the sync signal from the video camera 120, the microprocessor 154 reads a delay value previously stored in a location in memory. In the first exemplary embodiment of the electro-optical shutter apparatus 100, the delay value is a fixed value corresponding to about five (5) milliseconds of delay time preprogrammed into the software. Alternative embodiments of the electro-optical shutter apparatus 100 may incorporate a different fixed delay value, or a user selectable delay value selected through the user interface means 156. The microprocessor uses the delay value to implement a software counter to time a delay period of about five (5) milliseconds between detection of the sync signal and opening the LCD element 110.

At the end of the delay period, the microprocessor 154 reads a sample value previously stored in memory corresponding to the shutter angle signal from the user interface means 156. The sample value determines the open time of the LCD element 110 corresponding to the user-selected shutter angle. The correspondence between the sample value and the shutter angle may be accomplished by using, as examples, but not limited to, a software look-up table or a mathematical formula. The first exemplary embodiment of the electro-optical shutter apparatus 100 has four (4) possible shutter angle settings as shown by the table in FIG. 3. Alternative embodiments of the electro-optical shutter apparatus 100 may incorporate additional or different shutter angle settings.

Referring again to FIG. 4 and FIG. 5, after reading the sample value, the microprocessor 154 uses the sample value to implement a software counter to time a duration that the LCD element 110 will be open. In the first exemplary embodiment of the electro-optical shutter apparatus 100, after starting the counter, the microprocessor 154 generates an about five volt (+5V) signal LCD1 on electrical signal line 152 and an about zero volt (0V) signal LCD0 on electrical signal line 151. The signals LCD1 and LCD0 are transmitted to the LCD element 110 thereby opening the LCD element 110 and allowing light to be transmitted through the optical path 132 of the video camera 120, capturing the desired image.

At the end of the sample time period determined by the microprocessor 154 based on the sample value, the microprocessor 154 generates an about five volt (+5V) signal LCD0 on electrical signal line 151 and an about zero volt (0V) signal LCD1 on electrical signal line 152 thereby closing the LCD element 110. The LCD element 110 may be opened for different time periods based on the shutter angle setting selected by the user.

Many video cameras have a single, fixed sampling rate (i.e., samples-per-second) that approximately corresponds to a frame rate (i.e., frames-per-second) in a film movie camera. One typical video camera sampling rate is thirty (30) samples-per-second. At this sample rate, the video camera captures one image every about 0.033 seconds (33 milliseconds). In the always open default mode, the electro-optical shutter does not introduce any deblurring function into the captured images. This mode may be seen to correspond to a typical mechanical shutter angle of one hundred eighty (180) degrees in a film movie camera where the mechanical shutter exposes the film for approximately half the frame time and then blocks light from entering for the remaining time to allow the subsequent film frame to be moved into position in the camera.

It follows, then, that a shutter angle of ninety (90) degrees corresponds to a film frame being exposed for about half of the normally available exposure time. For the first exemplary embodiment of the electro-optical shutter apparatus 100, at a sample rate of thirty samples-per-second, a one hundred eighty (180) degree shutter angle equates to the LCD element 110 opening for about 0.0165 seconds (16.5 milliseconds), or about one-half (½) of the available video sampling time. Likewise, a ninety (90) degree shutter angle equates to the LCD element 110 opening for about 0.0083 seconds (8.3 milliseconds) or one-quarter (¼) of the available video sampling time, and a 45 degree shutter angle equates to the LCD element 110 opening for about 0.0041 seconds (4.1 milliseconds) or one-eighth (⅛) of the available video sampling time.

In the first exemplary embodiment of the electro-optical shutter apparatus 100, the LCD element 110 is a ferroelectric LCD element having the ability to open in about two hundred (200) microseconds (0.2 milliseconds) when an about five volt signal having the proper polarity is applied to the terminals 112, 114 of the LCD element 110. Similarly, the LCD element 110 has the ability to close in about two hundred (200) microseconds (0.2 milliseconds) when an about five volt signal having the opposite polarity is applied to the terminals 112, 114 of the LCD element 110. As can be seen from the above exemplary shutter angle sampling times, the about 0.4 millisecond total transition time for the LCD element 110 to open and to close is insignificant compared to the video sampling time and therefore does not degrade the image.

Unless commanded to open by the microprocessor 154, the LCD element 110 remains closed, except in the always open default mode. Opening the LCD element 110 for only a portion of the available sampling period reduces optical sampling time. This reduced optical sampling time captures a smaller range of motion of the subject during an action sequence. The motion blur effect is thereby reduced or eliminated by the smaller range of motion captured during each sampling period.

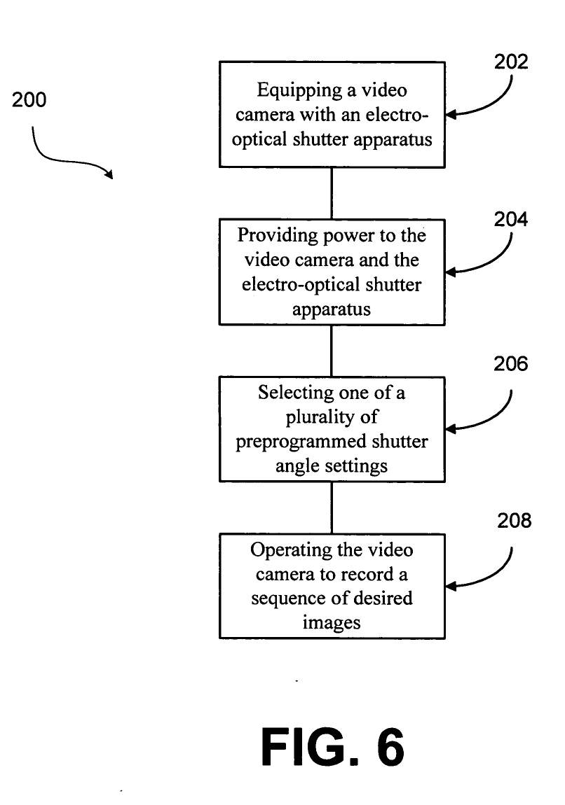

The flow chart of FIG. 6 shows the architecture, functionality, and operation of a possible implementation of the electro-optical shutter apparatus 100. In this regard, each block represents a module, segment, or step, which comprises one or more executable instructions for implementing the specified logical function. It should also be noted that in some alternative implementations, the functions noted in the blocks might occur out of the order noted in FIG. 6. For example, two blocks shown in succession in FIG. 6 may in fact be executed substantially concurrently or the blocks may sometimes be executed in the reverse order, depending upon the functionality involved, as will be further clarified herein.

The present invention includes a method 200 of providing optical video deblurring with an electro-optical shutter apparatus 100. The method 200 includes equipping a video camera 120 with an electro-optical shutter apparatus 100 (block 202). In addition, the method 200 includes providing power to the video camera 120 and the electro-optical shutter apparatus 100 (block 204). The method 200 also includes selecting one of a plurality of preprogrammed shutter angle settings (block 206). The method 200 further includes operating the video camera 120 to record a sequence of desired images (block 208).

The method 200 may further involve synchronizing a liquid crystal display element 110 to operation of the video camera 120 capturing the sequence of desired images in less than a full sampling time of the video camera 120 by selectively interrupting an optical path 132 with the liquid crystal display element 110 thereby optically reducing a motion blur. The method 200 may further involve pressing a button on a user interface means 156 to select the user selectable shutter angle setting. The method 200 may further involve turning a knob on a user interface means 156 to select a user selectable shutter angle setting.

The method 200 may further involve closing the electronically controllable shutter apparatus 100; detecting a signal to synchronize the electronically controllable shutter apparatus 100 to a video camera sampling system; reading a delay value from a computer memory location to initialize a delay counter; starting the delay counter to time a period required for the electronically controllable shutter apparatus 100 to remain closed; and monitoring the delay counter until it reaches the delay value.

The method 200 may further involve reading a sample value from a computer memory location to initialize a sample counter; starting the sample counter to time the period required for the electronically controllable shutter apparatus 100 to remain open; opening the electronically controllable shutter apparatus 100; monitoring the sample counter until it reaches the sample value; and closing the electronically controllable shutter apparatus 100.

While operation of the electro-optical shutter apparatus 100 has been described using a video sampling rate of thirty samples-per-second as an example, one of ordinary skill in the art will recognize that the electro-optical shutter will also function at other video sampling rates.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. An electro-optical shutter apparatus comprising:
a liquid crystal element disposed in an optical path of a video camera;
a programmable electronic control circuit in electrical communication with the liquid crystal element, and in electrical communication with the video camera, wherein the programmable electronic control circuit accepts at least one synchronizing electrical input signal from the video camera and processes the at least one synchronizing input electrical signal to produce at least one output electrical signal to control the liquid crystal element; and
a software program comprising an algorithm for processing the at least one synchronizing input electrical signal and for producing the at least one output electrical signal.

2. The electro-optical shutter apparatus of claim 1, further comprising a user interface means for providing an interface electrical input signal corresponding to a user selectable shutter angle setting to the programmable electronic control circuit wherein the user interface means is in electrical communication with the video camera and with the programmable electronic control circuit.

3. The electro-optical shutter apparatus of claim 2, wherein the user interface means further comprises a switch having a plurality of operable settings wherein the switch is in electrical communication with the programmable electronic control circuit whereby a user communicates a shutter angle setting to the programmable electronic control circuit.

4. The electro-optical shutter apparatus of claim 2, wherein the user interface means further comprises a display indicating the user selectable shutter angle setting.

5. The electro-optical shutter apparatus of claim 1, wherein the programmable electronic control circuit further comprises a microprocessor having internal storage memory.

6. The electro-optical shutter apparatus of claim 5, wherein the programmable electronic control circuit further comprises a storage memory device external to the microprocessor.

7. The electro-optical shutter apparatus of claim 1, further comprising a battery.

8. The electro-optical shutter apparatus of claim 1 further comprising a removable housing constructed and arranged for insertion in the optical path of the video camera.

9. The electro-optical shutter apparatus of claim 1 wherein the programmable electronic control circuit is disposed within a housing of the video camera, and wherein the liquid crystal element is disposed internally to the video camera in the optical path of the video camera.

10. An electro-optical shutter apparatus comprising:
a programmable electronic control circuit in electrical communication with a video camera, the programmable electronic control circuit comprising a microprocessor with storage memory, wherein the programmable electronic control circuit accepts at least one input electrical signal from the video camera and at least one input electrical signal from a user interface means and processes the input electrical signals to produce at least one output electrical signal;
a liquid crystal element disposed in an optical path of the video camera, wherein the liquid crystal element accepts the at least one output electrical signal from the programmable electronic control circuit thereby causing the liquid crystal element to become opaque blocking light transmittal through the optical path or to become transparent allowing light transmittal through the optical path; and
a software program resident in the storage memory for execution by the microprocessor, wherein the software program comprises an algorithm and data for evaluating the input electrical signals and for producing the at least one output electrical signal accepted by the liquid crystal element.

11. The electro-optical shutter apparatus of claim 10 further comprising a removable housing constructed and arranged for insertion in the optical path of the video camera.

12. The electro-optical shutter apparatus of claim 10 wherein the programmable electronic control circuit is disposed within a housing of the video camera, and wherein the liquid crystal element is disposed internally to the video camera in the optical path of the video camera.

13. An electro-optical shutter apparatus comprising:
means for electronically controlling a shutter selectively blocking light entering a lens of a video camera;
means for programmably controlling the means electronically controlling the shutter and for synchronizing the means for electronically controlling the shutter to an operation of the video camera;
means for user interface operable to allow a user to input a user selectable shutter angle to the means for programmably controlling.

14. A method of providing optical video deblurring with an electro-optical shutter apparatus, the method comprising the steps of:
equipping a video camera with an electro-optical shutter;
providing power to the video camera and the electro-optical shutter;
selecting one of a plurality of preprogrammed shutter angle settings; and
operating the video camera to record a sequence of desired images.

15. The method of claim 14 further comprising:
synchronizing a liquid crystal display element to operation of the video camera; and
capturing the sequence of desired images in less than a full sampling time of the video camera by selectively interrupting an optical path with the liquid crystal display element thereby optically reducing a motion blur.

16. The method of claim 14, further comprising the step of pressing a button on a user interface means to select the user selectable shutter angle setting.

17. The method of claim 14, further comprising the step of turning a knob on a user interface means to select a user selectable shutter angle setting.

18. The method of claim 14 further comprising:
closing the electronically controllable shutter;
detecting a signal to synchronize the electronically controllable shutter to a video camera sampling system;
reading a delay value from a computer memory location to initialize a delay counter;
starting the delay counter to time a period required for the electronically controllable shutter to remain closed; and
monitoring the delay counter until it reaches the delay value.

19. The method of claim 18 further comprising:
reading a sample value from a computer memory location to initialize a sample counter;
starting the sample counter to time the period required for the electronically controllable shutter to remain open;
opening the electronically controllable shutter;
monitoring the sample counter until it reaches the sample value; and
closing the electronically controllable shutter.
